(19) United States
(12) Patent Application Publication
(10) Pub. No.: US 2006/0274071 A1
(43) Pub. Date: Dec. 7, 2006

(54) Method of predicting the appearance of at least a portion of an individual's body

(75) Inventor: Roland Bazin, Bievres (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 11/237,854

(22) Filed: Sep. 29, 2005

Related U.S. Application Data
(60) Provisional application No. 60/616,223, filed on Oct. 7, 2004.

(30) Foreign Application Priority Data
Sep. 29, 2004 (FR) 04 10323

(51) Int. Cl. G06T 15/70

(52) U.S. Cl. 345/475

(57) ABSTRACT

The present invention relates to a method of predicting the appearance of an external portion of the human body as a function of time and/or treatment, in which method at least three images are generated, the images corresponding to different grades of at least one appearance parameter as a function of time and/or treatment, the variation of at least said appearance parameter over said images being non-linear.

The present invention relates in particular to methods and systems for simulating and/or tracking and/or predicting changes in the appearance of at least a portion of an individual's body as a function of time and/or as a function of treatment.

U.S. Pat. No. 6,761,697 discloses a method of predicting changes in at least one condition of an external portion of an individual's body.

U.S. Pat. No. 4,276,570 describes a method and a system enabling an image of a face to be produced at different ages. A first image is acquired of an individual, and a second image is acquired of another individual who is older or younger depending on whether it is desired to simulate aging or rejuvenation. Thereafter, the images are analyzed in such a manner as to store the differences between them. The differences are then added to the first image so as to simulate aging, for example.

In such a method, the particular second image that is selected is of crucial importance concerning the results of the simulation, and it can happen that the simulation is not sufficiently realistic.

There exists a need to be able to predict the changes in the appearance of at least a portion of an individual's body as a function of time and/or of treatment, and in particular to do so in a plurality of successive stages.

Such prediction can be useful, e.g. in order to satisfy curiosity, to become aware of the need for treatment, or of the harmful effects of an environment, or indeed to apply makeup more effectively for the purpose of aging or rejuvenating the appearance.

There also exists a need to have available an atlas for evaluating appearance parameters with reference to age ranges rather than to arbitrary grades.

The invention seeks to solve these needs in full or in part.

In one of its aspects, the invention provides a method of predicting the appearance of an external portion of the human body as a function of time and/or of treatment, in which method at least three images are generated, these images corresponding to different grades of at least one appearance parameter as a function of time and/or of treatment, with variation in this appearance parameter advantageously being non-linear.

The non-linearity of variation in at least one appearance parameter enables changes in the appearance of at least a portion of an individual's body to be simulated in a manner that is relatively realistic.

Where appropriate, the images may be generated from a single image of the person for whom the prediction method is implemented.

The term “image” should be understood broadly and covers representations that are plane or in relief, photographs, drawings, and dummies. The images may be displayed or printed or may remain in the form of electronic files. By way of example, a 3D image enables the observer to change direction of observation. Where appropriate, the images may be adapted to stereoscopic viewing.

For example, when it is desired to predict the appearance of the face at various stages, the invention makes it possible to cause the various signs of aging to appear substantially in the same order as they would appear in reality and to cause them to vary as substantially the same rate as they would vary in reality.

When the variation is said to be “non-linear” it should be understood that the variation is not proportional to the time and/or treatment variable over at least a period of time or of treatment.

By way of example, the time variable can be expressed in years, or using some shorter time unit, particularly when delaying with treatment.

With treatment, the variable can be the duration of the treatment or the number of doses of a substance that has been applied and/or administered, for example.

By way of example, variations in grades as a function of time and/or treatment may follow a relationship that is not linear, for example it may be polynomial, or it may be linear in segments only. The relationship may, for example, be a polynomial function of the time variable, e.g. a polynomial of the third degree.

The relationship is advantageously statistical, being determined from observations of the appearance parameter in a reference population.

By way of example, the prediction can make use of at least two relationships, and in particular two non-linear relationships, relating to at least two appearance parameters, these relationships preferably being as observed in a reference population, or the prediction can indeed involve even more relationships, for example at least three, better at least five relationships, which may be linear or non-linear.

Various appearance parameters can be predicted by using respective relationships, for example at least two relationships as mentioned above, that differ from each other in terms of their abscissa intercepts and/or slope of their tangents over different periods of time.

At least one appearance parameter may be varied in application of a relationship having at least two portions with different tangent slopes.

The above-mentioned reference population may comprise a plurality of age ranges for at least one appearance parameter, and a statistical relationship for variation in this parameter can be determined as a function of the age ranges, with this relationship being subsequently usable for the above prediction. Where appropriate, the age range may be restricted to a single age.

Each age range of the reference population may be associated with a grade that is representative of the appearance parameter for said age range. By way of example, the grade may be any numerical value. The representative grade may then, for example, be the mean value or the median value of the observed grade.

The prediction method may thus include generating a succession of images associated with different age ranges.

By way of example, at least one image may include a first portion coming from at least one real image of the individual constituting the subject of the simulation, together with a second portion coming from the simulation, said second portion being integrated in the image in such a manner as to blend therein. Morphing software can be used for this purpose. Such software can be operated manually or automatically.

Each image corresponding to the prediction result for an age range may be generated as a function of the grade expected for at least one appearance parameter of the individual concerned in said age range, and as a function of the appearance of said appearance parameter of at least one person in the reference population for which the appearance parameter has been evaluated as having substantially the same grade as the expected grade or a grade that is close thereto. By way of example, the image may be generated from at least two images of individuals in the reference population having evaluated grades on either side of the expected grade.

The appearance parameters may be representative of aging, in particular for the skin of the face, and they may be selected, for example, from the number of crow's foot wrinkles, the severity of crow's foot wrinkles, of forehead wrinkles, of the nasolabial folds, of sagging of the chin, of bags under the eyes, of pigmented spots, of microcirculation, of baldness, of canities (grayness of the hair), or the size of face pores, amongst others.

By way of example, the appearance parameters may also be representative of gaining or losing weight, of photo-aging, or of the consequences of pregnancy or of surgery.

In another of its aspects, the invention: also provides a method of showing up the effects of a treatment, in which an individual is enabled to become aware both of a first predicted result and of a second predicted result as obtained by implementing the method defined above, with the second predicted result being obtained by using one or more variation relationships that take account of the effect of the treatment on the variation of at least one appearance parameter.

The individual may become aware of the first and second results at the same time or at different times.

By way of example, the results may be presented in the form of images simulating the appearance of the individual with and without treatment.

By way of example, the treatment may comprise applying and/or taking cosmetic, dermatological, or other substances, in particular food supplements, following a diet, massaging, and/or physical exercise, and surgery.

In particular, the treatment may comprise taking and/or applying substances for slowing photo-aging and/or applying and/or taking slimming products.

In another of its aspects, the invention also provides an atlas comprising at least three images associated with respective age ranges, the three images corresponding to different grades of at least one appearance parameter in common, with the variation in this appearance parameter being non-linear, at least for these images.

In another of its aspects, the invention also provides an atlas comprising at least three images associated with respective age ranges, these three images corresponding to different grades of at least one appearance parameter in common, each image associated with an age range corresponding to the grade that is representative of said appearance parameter in said age range for a reference population.

By way of example, for an age range in the reference population, the representative grade is the mean grade or the median grade.

Given the grade that is representative of an age range, the image associated with that age range is constituted, for example, by an image taken of an individual in the reference population for whom the evaluated grade is close or equal to the representative grade, or it is an image generated by morphing from images of individuals in the reference population having respective evaluation grades on either side of the representative grades, for example.

For each age range, the atlas may include at least two images corresponding to grades departing in predefined manner from the representative grade, e.g. by one or more standard deviations, leading towards extreme grades observed in the reference population or to grades that are a function of grade distribution within the reference population, e.g. departing from the median grade by some predefined number of percentiles.

In another of its aspects, the invention also provides a system enabling variation in the appearance of at least a portion of the body of an individual to be simulated, the system comprising:
means for acquiring the initial grade of at least one appearance parameter; and
means for calculating at least one expected grade for said appearance parameter as a function of a time lapse and/or of a treatment, and as a function of at least one variation relationship for said appearance parameter as a function of time and/or treatment in a reference population. This variation relationship may be a non-linear relationship.

The system may also advantageously include:
graphics generator means for graphically generating at least one image simulating the appearance of the portion of the body as a function of the grade expected for the appearance parameter.

The calculation means may be arranged to calculate the grades expected for a grade of appearance parameters as a function of variation relationships for said appearance parameters as observed in the reference population.

The graphics generator means may, for example, serve to display a succession of images simulating variation in the appearance of the appearance parameter as a function of time and/or treatment, depending on the calculated expected grades.

The calculation means may be arranged to access at least one file in which the variation relationships are recorded. These relationships may be non-linear statistical relationships. Where appropriate, the file may be accessed via a computer and/or a telephone network.

The calculation means and the graphics generator means may comprise one or more computers, for example a micro-computer on its own or connected to a remote server.

The invention also provides a method of promoting the sale of a product and/or a treatment, the method comprising the following steps:
putting forward a simulation of variation in at least one appearance parameter without treatment; and
putting forward a simulation of variation in the same appearance parameter with treatment.

The promotion may be carried out using any communications channel. In particular it may be carried out by a sales person directly at a point-of-sale, by radio, television, or telephone, in particular in the form of commercials or short messages. It may also be carried in the press or in any other document, in particular for advertising purposes. It may also be carried out over the Internet, or any other suitable computer network or mobile telephone network. It may also be applied directly to the product, in particular to its packaging or to instructions associated therewith.

In another of its aspects, the invention also provides a method of predicting at least one appearance parameter of an external portion of the human body as a function of time and/or treatment, in which method the prediction is performed as a function of at least one variation relationship determined from observations of said appearance parameter made in a reference population.

The term “observation” should be understood broadly and covers any type of visual and/or instrumentally-measured evaluations. The portion of the body may comprise the face, the bust, a limb, or the entire body, for example.

By way of example, a result of the prediction may be presented in the form of one or more images simulating the appearance of the appearance parameter(s) as a function of time and/or treatment.

The invention can be better understood on reading the following detailed description of non-limiting implementations thereof, and on examining the accompanying drawings, in which:

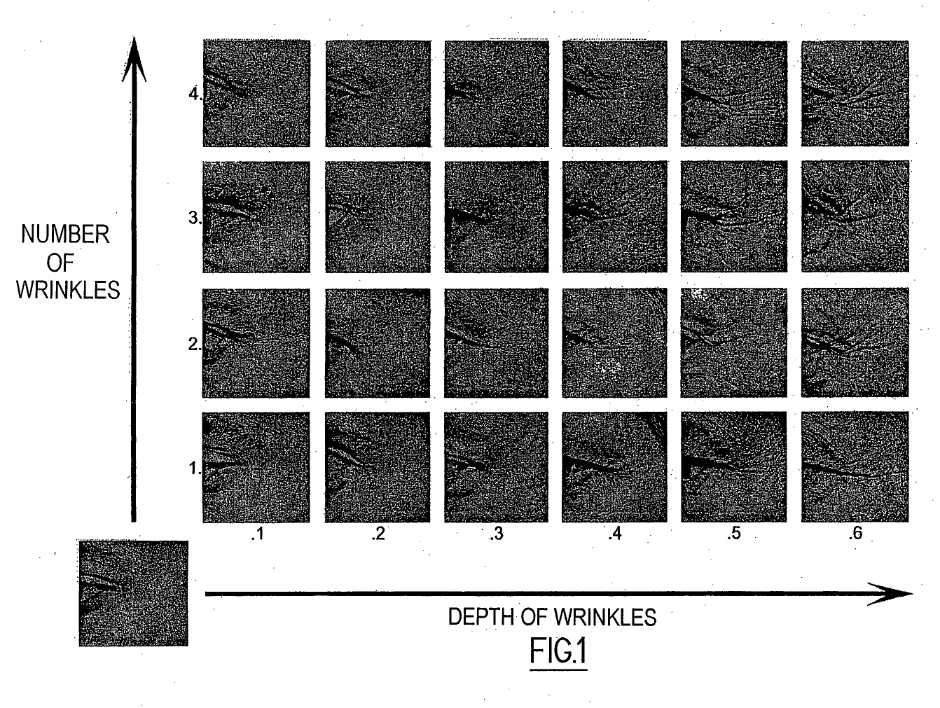

FIG. 1 is a diagram showing an atlas of crow's foot wrinkles;

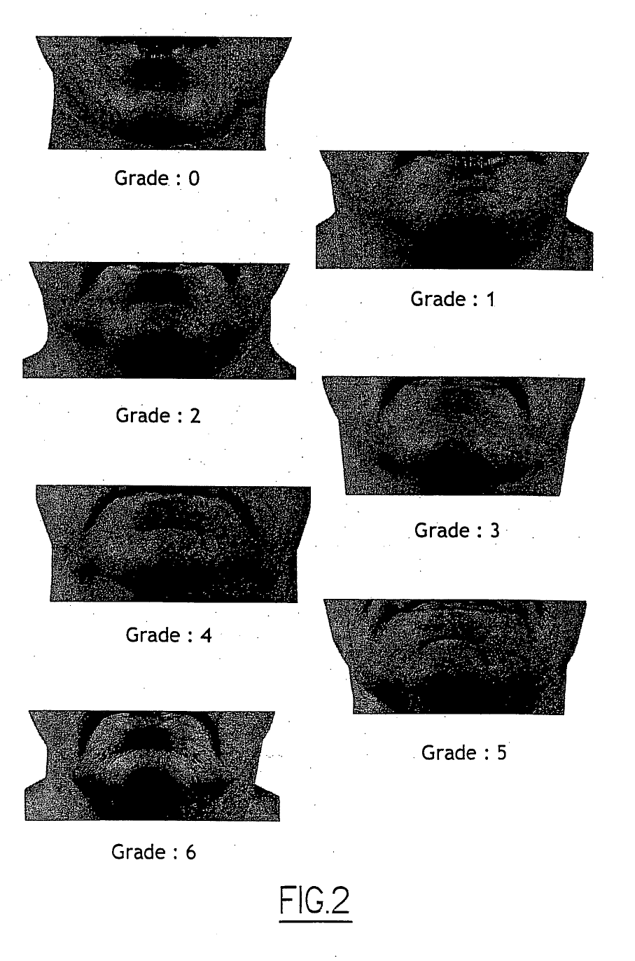

FIG. 2 is a diagram showing an atlas of chin sag;

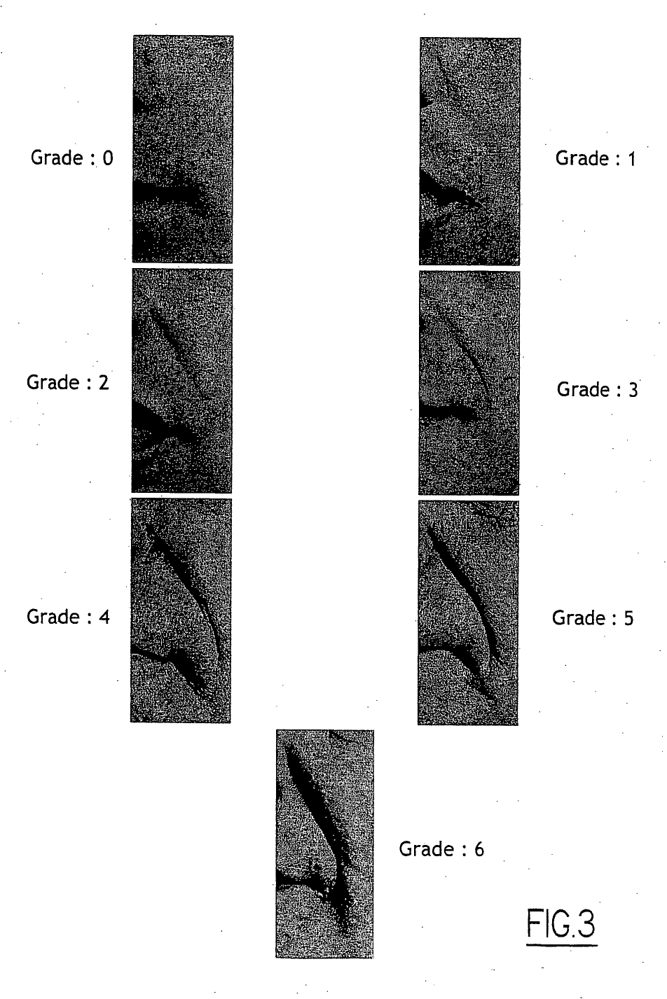

FIG. 3 is a diagram showing an atlas for the nasolabial fold;

FIG. 4 is a diagram of an atlas for wrinkles of the forehead;

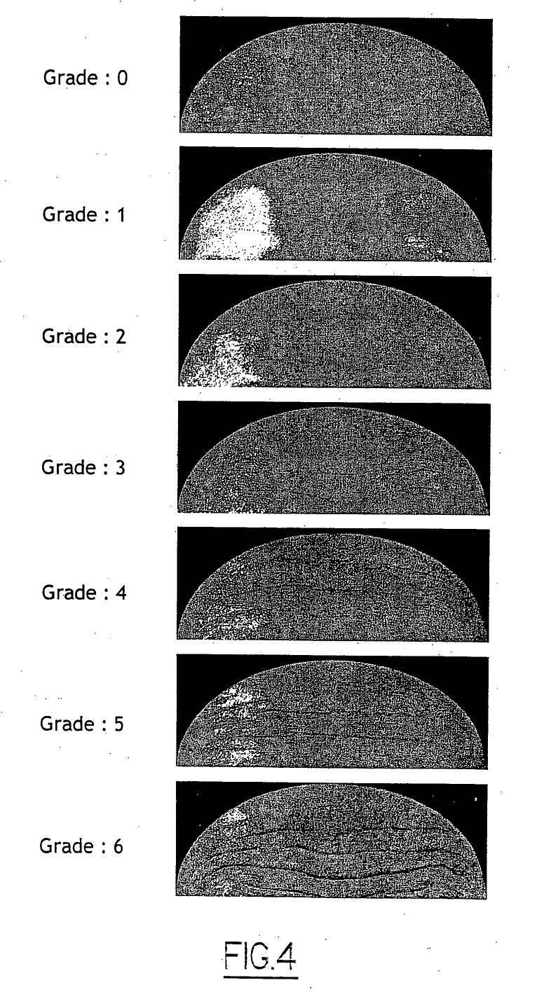

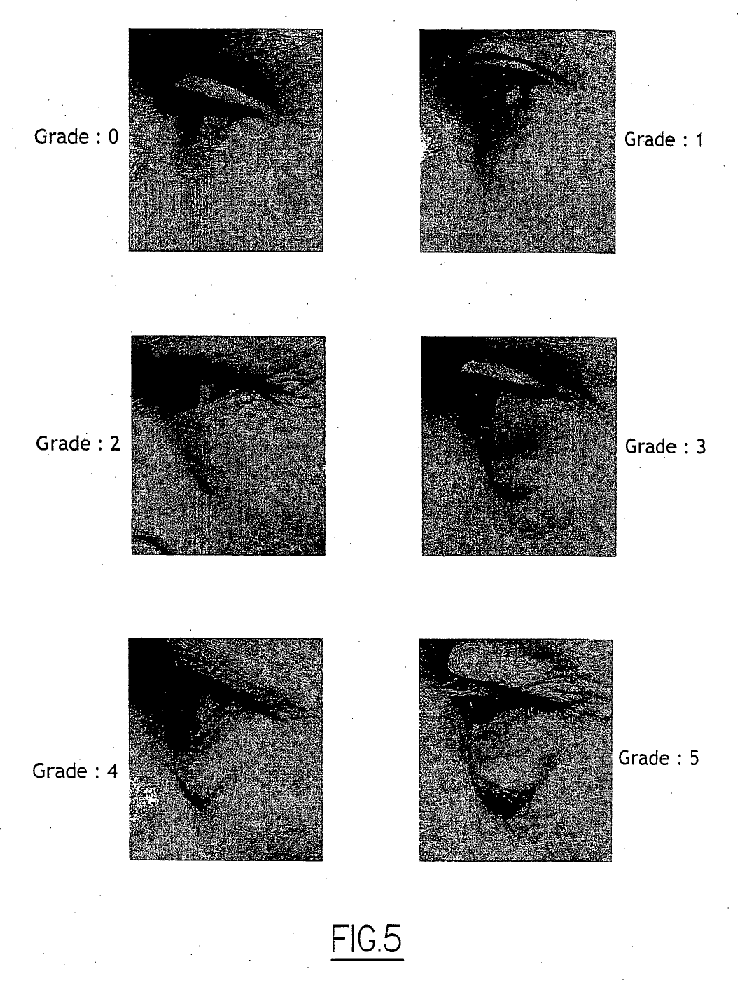

FIG. 5 is a diagram showing an atlas of bags under the eyes;

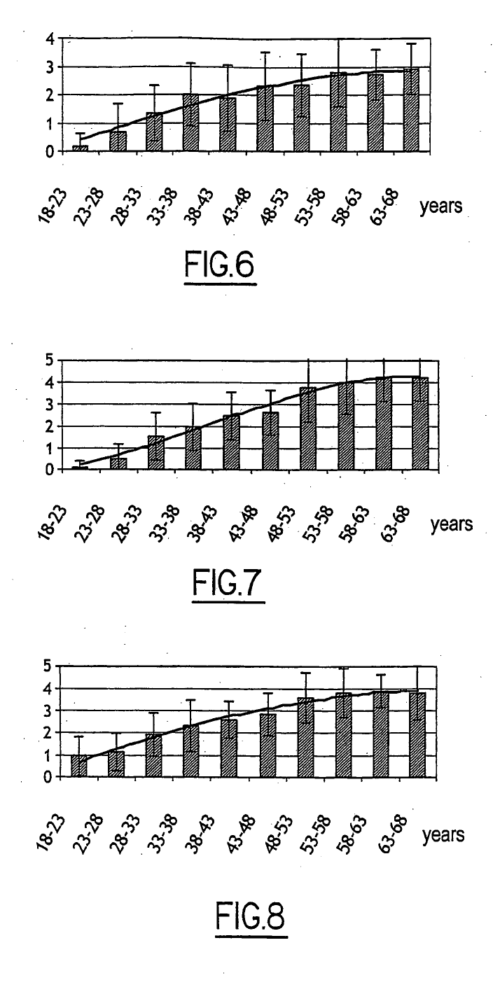

FIG. 6 shows the variation in the mean grade for the number of crow's foot wrinkles in Caucasian men as a function of age range;

FIG. 7 shows the variation in the mean grade for the severity of crow's foot wrinkles in Caucasian men as a function of age range;

FIG. 8 shows the variation in the mean grade for the severity of forehead wrinkles in Caucasian men as a function of age range;

FIG. 9 shows the variation in the mean grade for the severity of the nasolabial fold in Caucasian men as a function of age range;

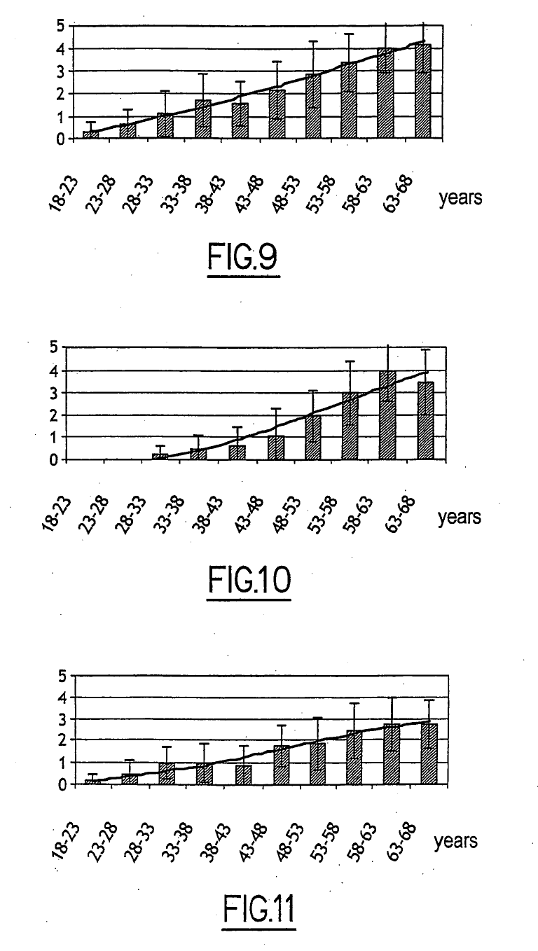

FIG. 10 show the variation in the mean grade for the severity of chin sag in Caucasian men as a function of age range;

FIG. 11 shows the variation in the mean grade for the severity of bags under the eyes in Caucasian men as a function of age range;

FIG. 12 shows the respective rates of different relationships for variation in appearance parameters characterizing aging in Caucasian men as a function of age range;

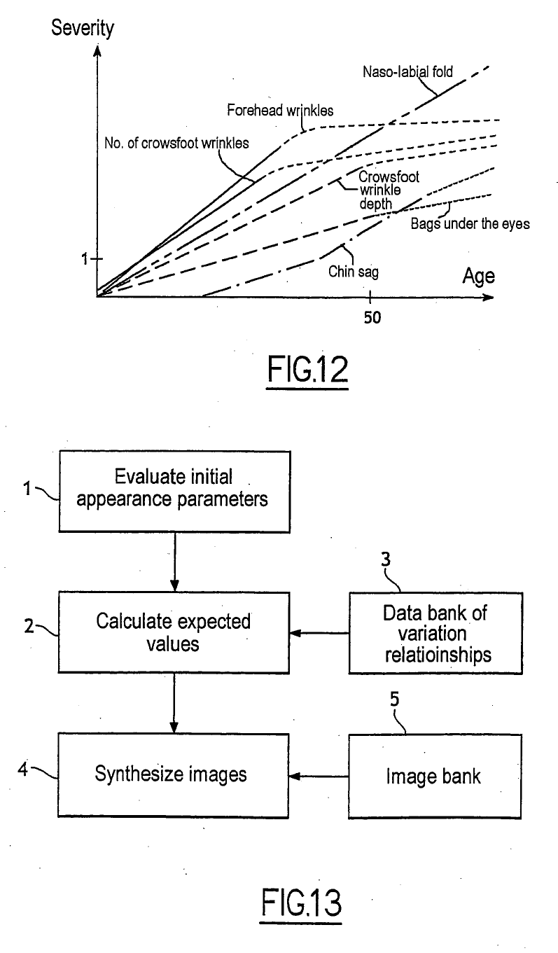

FIG. 13 is a block diagram showing an example of the method of the invention;

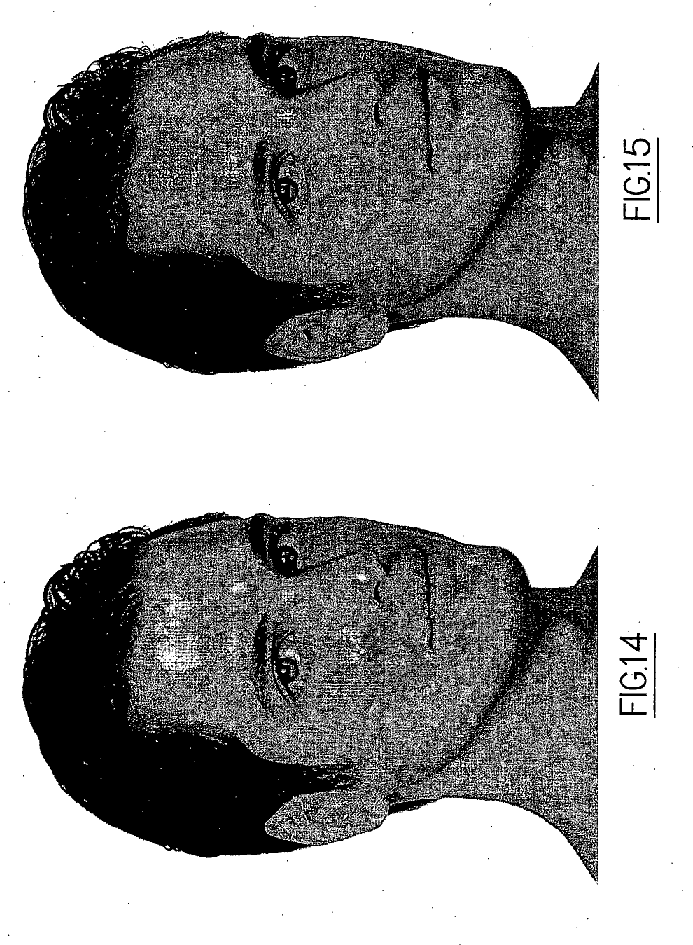

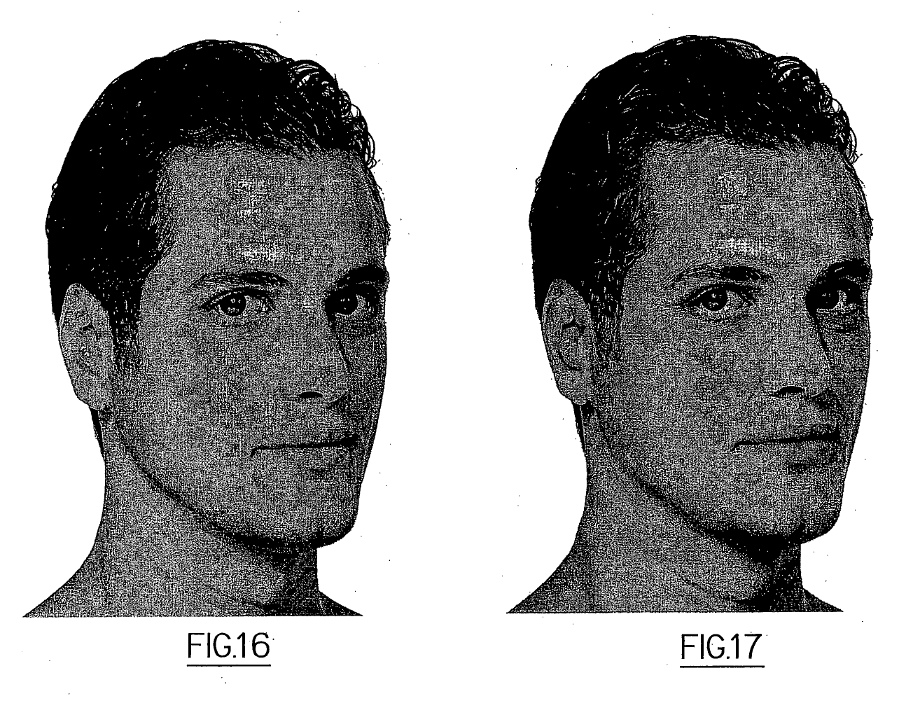

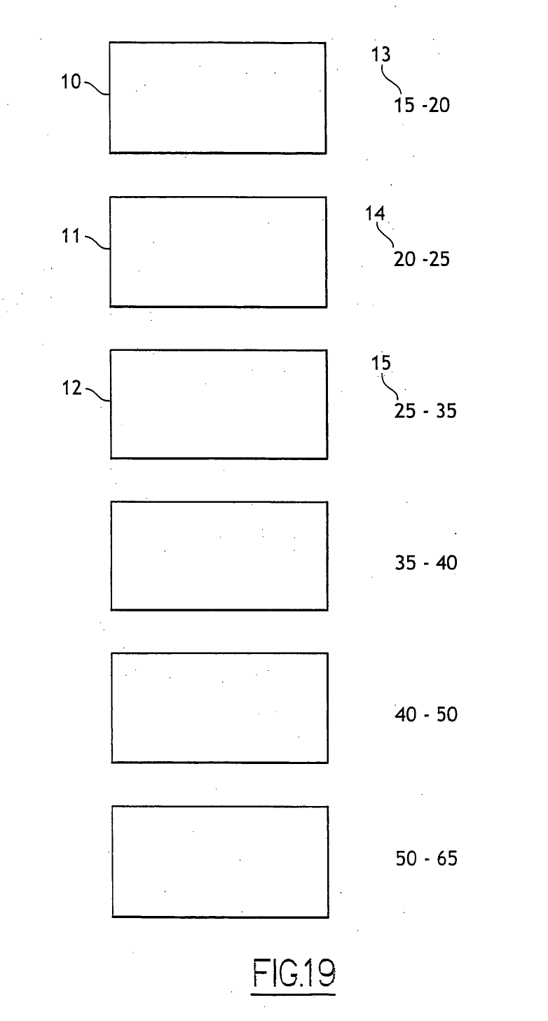

FIGS. 14 to 18 are diagrams giving examples of images obtained by implementing the method of FIG. 13;

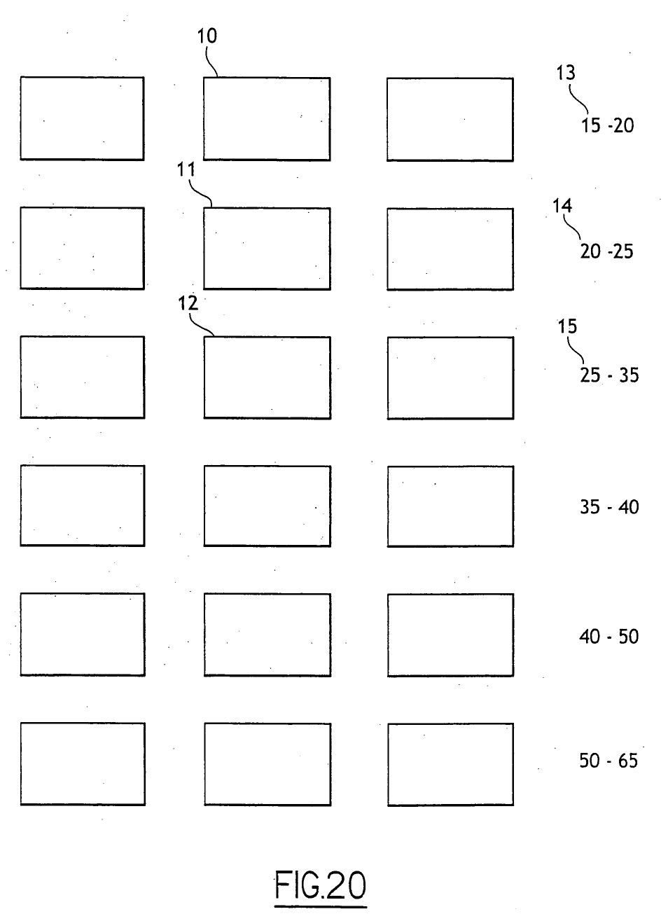

FIGS. 19 and 20 are examples of an atlas in which each image in the atlas is associated with an age range;

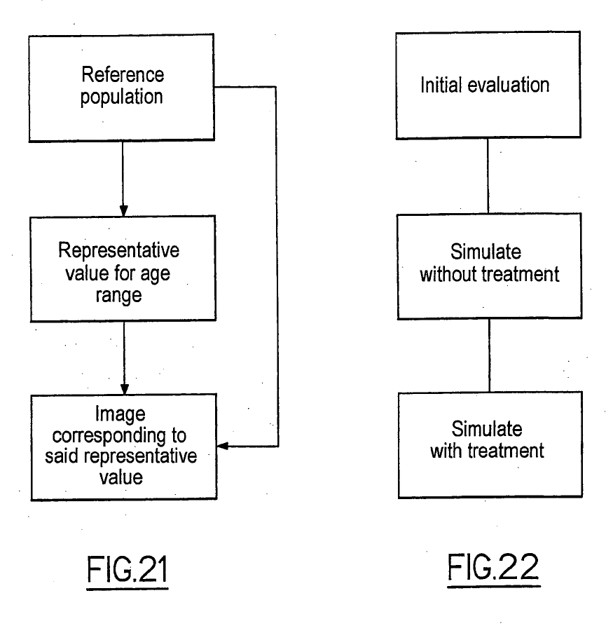

FIG. 21 is a block diagram showing an example of the method enabling an atlas as shown in FIG. 19 or 20 to be made;

FIG. 22 is a block diagram showing an example of a method enabling the effect of a treatment to be shown;

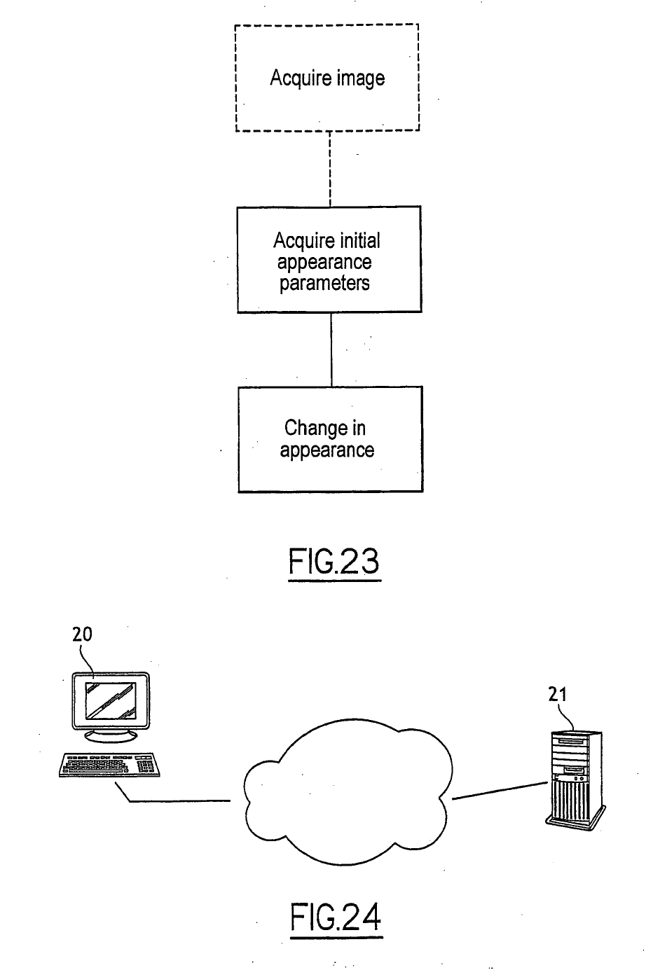

FIG. 23 is a block diagram showing a method of simulating variation in appearance; and

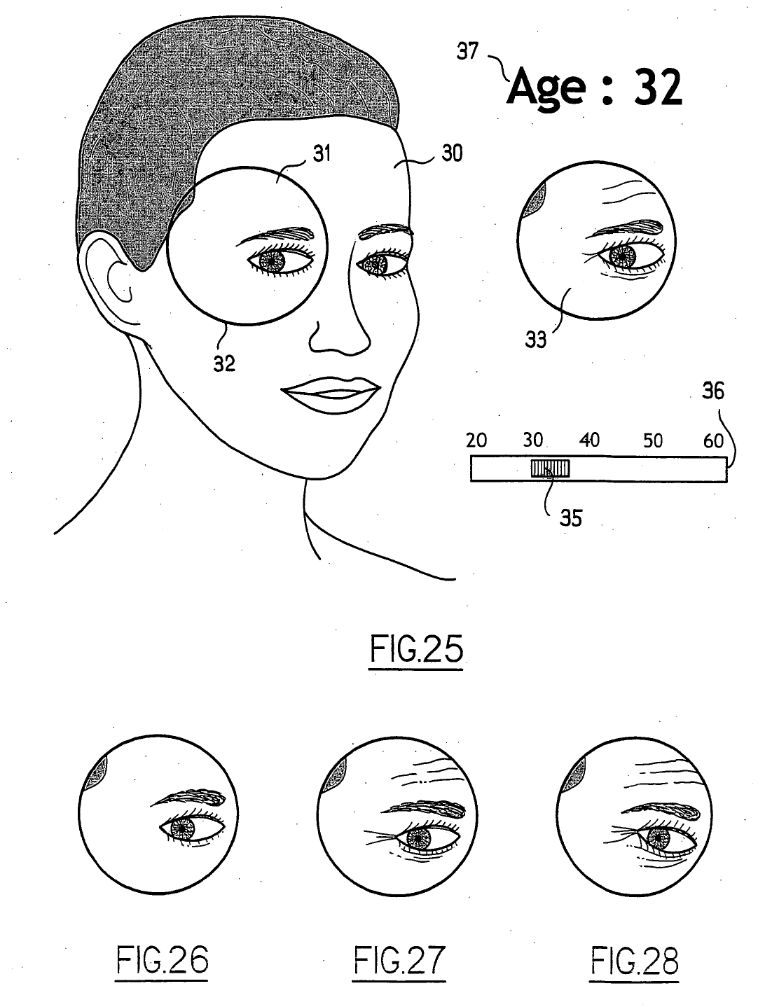

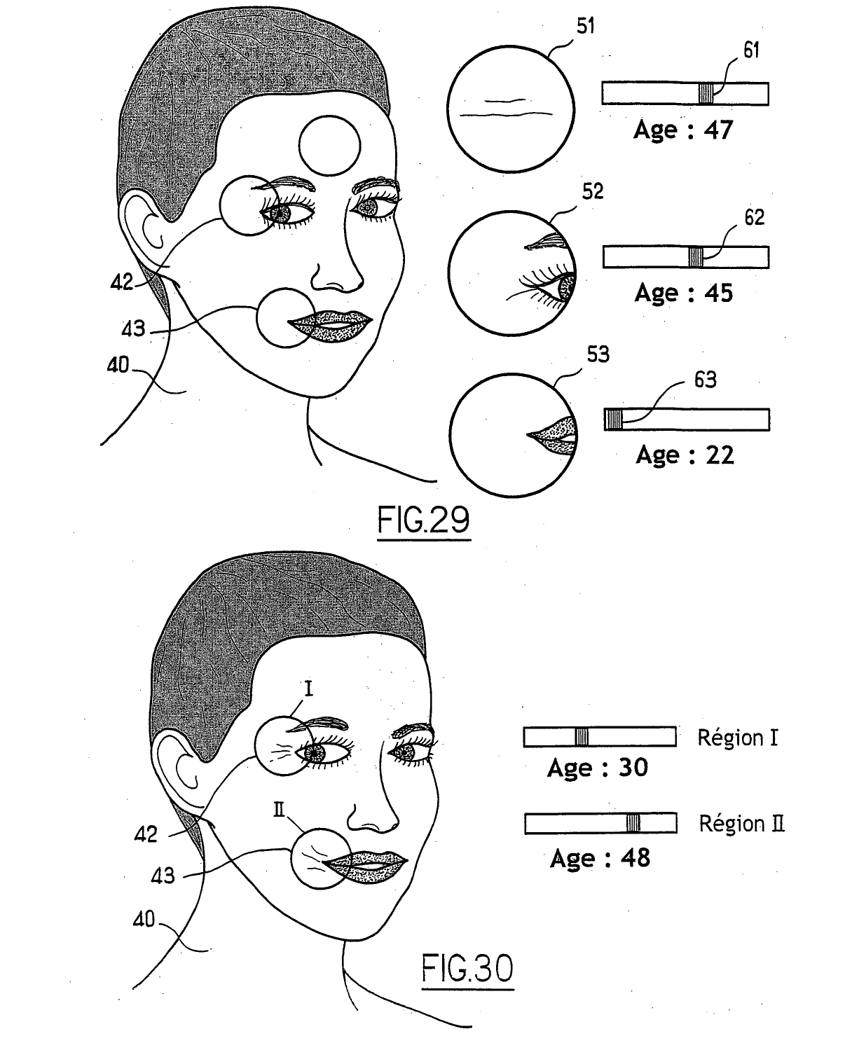

FIG. 24 is a diagram showing the possibility of processing data remotely.

FIGS. 1 to 5 show various examples of atlases that can be used for evaluating appearance parameters characteristic of aging in a reference population comprising a plurality of age ranges, e.g. a population of Caucasian men.

By way of example, the number and the severity of crow's foot wrinkles can be evaluated in the reference population by using the atlas of FIG. 1, the severity of chin sag by using the atlas of FIG. 2, the severity of the nasolabial fold by using the atlas of FIG. 3, the severity of forehead wrinkles by using the atlas of FIG. 4, and the severity of bags under the eyes by using the atlas of FIG. 5.

Thus, for each age range, a grade is obtained that is associated with the appearance parameter, e.g. a mean value or a median value.

The atlases shown in FIGS. 1 to 5 are merely examples, and the evaluation can be performed in other ways, for example by using the method described in patent application EP 1 216 658.

Evaluation may be carried out visually, e.g. by an operator trained for this purpose.

In a variant, the evaluation may be performed automatically, e.g. by image processing. U.S. Pat. No. 6,571,003, the contents of which is incorporated herein by reference, mentions algorithms enabling defects of the face to be located.

FIG. 6 shows how the mean grade for the number of crow's foot wrinkles varies in men as a function of various age ranges in the reference population, FIG. 7 shows variation in the mean grade for the severity of crow's foot wrinkles as a function of the same age ranges, FIG. 8 shows the variation in the mean grade for the severity of forehead wrinkles, FIG. 9 shows the variation in the mean grade for the severity of nasolabial fold, FIG. 10 shows variation in the mean grade for the severity of chin sag, and FIG. 11 shows the variation in the mean grade for the severity of bags under the eyes.

By fitting third-degree polynomial curves to the various mean values obtained per age range, it is possible to obtain statistical relationships for variation in the appearance parameters in question as a function of time, which relationships are not linear, having the form y=ax³+bx²+cx, where x is the time variable.

The following table is obtained:

| | c | b | a |
|---|---|---|---|
| Number of crow's | +0.4181 | −0.0036 | −0.0017 |
| foot wrinkles | | | |
| Severity of crow's | +0.1754 | +0.1005 | −0.0076 |
| foot wrinkles | | | |
| Severity of | +0.6743 | −0.0241 | −0.0004 |
| forehead wrinkles | | | |
| Severity of | +0.2723 | +0.0235 | −0.0008 |
| nasolabial fold | | | |
| Severity of chin | −0.3218 | +0.1281 | −0.0057 |
| sag | | | |
| Severity of bags | +0.0986 | +0.0434 | −0.0024 |
| under the eyes | | | |

From the various values of the coefficients a, b, and c, it can be seen that the nasolabial fold is a clinical sign that is highly representative of age in men and that it continues to progress regularly with age.

Transverse wrinkles on the forehead and to a lesser extent the number of crow's foot wrinkles are early signs of aging in men, with variation slowing down around age 50 or 55.

The depth of crow's foot wrinkles and the severity of bags under the eyes vary, but more slowly, with age up to around age 50, beyond which their rate of variation slows down further.

Sagging of the chin does not occur until later, starting at about age 40 and then varying more quickly.

FIG. 12 is a diagram showing the respective rates for these variation relationships as a function of age. It can be seen that variation in certain appearance parameters can be approximated by straight line segments over certain periods of time, that the slopes for a given appearance parameter can vary over time, and that the various relationships do not all present the same slopes.

Knowledge of real variation relationships makes it possible to provide more realistic predictions of the appearance of at least a portion of the body of an individual as a function of time and/or of treatment, e.g. by implementing the method shown in FIG. 13.

In this method, in a first step 1, the appearance parameters of the individual constituting the subject of the simulation are evaluated. For example each of the appearance parameters can be given a grade by using the above-mentioned atlases or by implementing an image processing method.

Once an initial grade has been determined for each appearance parameter, the individual can be positioned on the various curves shown in FIGS. 6 to 11.

Thereafter, the grades to be expected at an older age can be predicted in a step 2 by performing calculations based on the curves given in FIGS. 6 to 11, e.g. by shifting along the abscissa axis by the length of time representing the period for which expected grades are to be determined, with these grades being given by the corresponding ordinate values.

In the example under consideration, calculation is performed by using the relationships of FIGS. 6 to 11, but naturally other relationships could be used, for example, as a function of an individual's ethnic origin, sex, other typological factors, and/or environmental factors such as place of residence, frequency of exposure to the sun, etc.

Once the expected grades are known, a synthetic image can be generated automatically or manually, based on an image of the individual constituting the subject of the simulation.

For each appearance parameter, given the expected grade, it is possible to search through an image bank 5 for an image that reproduces the appearance of said appearance parameter with that grade. This image is then used as a reference for reproducing substantially the same degree of severity for the appearance parameter in the synthesized image, e.g. using a morphing method, with the image that is taken from the image bank being incorporated at least in part in the synthesized image, for example.

For a given individual, the various signs representative of aging do not appear simultaneously and do not vary at the same rate, as shown in FIGS. 14 to 18.

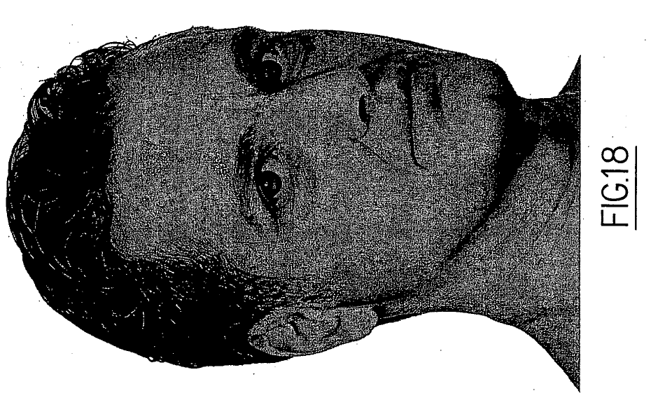

FIG. 14 corresponds to the initial image of the individual constituting the subject of the simulation, aged 23. FIGS. 15 to 18 correspond respectively to the appearance expected at ages 33, 43, 53, and 63.

The invention can also be used for simulating rejuvenation. Under such circumstances, the curves of FIGS. 10 to 11 can be used, only this time by shifting through the corresponding number of years to the left.

A method is described below with reference to FIG. 21 that enables atlases to be generated of the kinds shown in FIGS. 19 and 20.

Each of these atlases comprises a succession of images, at least three images, 10, 11, and 12, that correspond to different grades of an appearance parameter, e.g. one of those mentioned above, that are characteristic of aging in men.

The images in the atlas are associated with age ranges, and for the example shown, the three images 10, 11, and 12 correspond to respective age ranges 13, 14, and 15.

The term “grade in terms of age range” can be preferable for the public, since the grades commonly used are not easily associated with reality.

In order to generate the images in the atlases, a representative grade can initially be determined for each given age range in a reference population, e.g. by determining the mean grade or the median grade.

Once this representative grade is known, the image of an individual having a grade that is evaluated as being substantially equal to said representative grade can be extracted from the reference population, or an image correspond to said representative grade can be generated by morphing from two available images of individuals who have been evaluated as having grades on either side of the representative grade.

For example, if the representative grade for a given age range has a numerical value equal to 4, it is possible to use an image of an individual in the reference population for whom the evaluated grade has the same value 4.

However, if the representative grade should, for example, have a numerical value equal to 3.5, and should there be no individual in the age range under consideration of the reference population evaluated as having this particular value, then an intermediate image can be generated by morphing from images of individuals in the reference population having respective grades of 3 and 4.

It is thus possible to produce an atlas having images 10, 11, and 12 that are derived from different respective individuals, at least indirectly. In these images, the corresponding appearance parameter may vary in a manner that is not linear. For example the image 10 may correspond to a grade of 3.5, the image 11 to a grade of 4.5, and the image 12 to a grade of 6, while the time intervals between the age ranges 13, 14, and 15 remain constant, for example.

In the example of FIG. 20, the atlas includes not only images corresponding to the grade that is representative of each age range, but also at least one other image, and specifically two other images 17 and 18 on either side of the representative grade.

By way of example, these images may correspond to grades that depart from the representative grade by one standard deviation when the representative grade is a mean grade, or by a given percentile when the representative grade is a median grade. It is also possible, for example, for these images to constitute the extreme grades observed in the reference population for the given age range.

For example, if the image 10 corresponds to a representative grade of 3.5, and if the standard deviation is 0.5, then the images 17 and 18 may correspond respectively to grades 3 and 4, assuming that it has been decided to use a presentation relying on standard deviation.

The atlases may be printed or they may be displayed on a screen. When displayed, the images may be displayed simultaneously or separately on a screen. For example, the images may be displayed sequentially.

It is also possible for the images of an atlas not to be displayed but to be in the form of computer files having a given format, for example. These files can be designed for use in a system for automatically evaluating the grade of an appearance parameter and/or for simulating the appearance and/or predicting the appearance of an appearance parameter after a certain duration and/or after a given treatment.

The age range may be displayed together with the image. The image may also be displayed in response to a request containing the corresponding age range.

The images of the atlas may be recorded on a computer medium such as an electronic memory or an optical or a magnetic disk, e.g. indexed in a manner that relates to the corresponding age ranges.

The images in the atlas may also be the heads of dummies, or they may be drawings, for example.

By way of example, the invention can be implemented so as to enable a consumer to see the effect of a treatment, e.g. an antiwrinkle treatment, peeling, or a diet.

To do this, the parameters of an individual can be evaluated initially, e.g. visually or by processing one or more images of the individual, and then variation in appearance can be simulated with and without the treatment, using at least one variation relationship as observed in a reference population, at least for simulating appearance without treatment. The variation relationship(s) used for predicting appearance with treatment may be relationships that are derived at least in part from observation, or that are calculated.

Two images simulating appearance with or without treatment can then be displayed.

In an example where the treatment is antiwrinkle treatment, e.g. by injecting botulinum toxin, the relationship for variation with treatment is as observed in a reference population that has been subjected to treatment of this type.

The invention can be implemented manually or automatically.

For example, a system including acquisition, calculation, and graphics generator means can be used.

The initial grades for the appearance parameters can be acquired via a keyboard, e.g. following visual evaluation, or by image processing, after taking at least one image of the individual in question.

This acquisition can take place on the same premises as subsequent data processing, e.g. at a point-of-sale or in a beauty parlor, or it may take place at a different location.

By way of example, the initial grades for the appearance parameters can be acquired, as shown in FIG. 24, by means of a computer 20, with the corresponding data being transmitted over a network, e.g. the Internet, to a remote server 21, which in return delivers a result, accompanied where appropriate with a prescription and/or advice and/or shipping of a product.

Naturally, the invention is not limited to the examples described above.

The appearance parameters need not relate to deterioration in the appearance of the face, but may relate, for example, to the appearance of the body, in particular weight gain with age, pregnancy, or skin damage due to photo-aging.

Throughout the description, including in the claims, the term “comprising a” should be understood as being synonymous with “comprising at least one” unless specified to the contrary.

1. A method of predicting the appearance of an external portion of the human body as a function of time and/or treatment, in which method at least three images are generated, the images corresponding to different grades of at least one appearance parameter as a function of time and/or treatment, the variation of at least said appearance parameter over said images being non-linear.

2. A method according to claim 1, characterized by the fact that said appearance parameter at least varies in compliance with a variation relationship determined from observations of said appearance parameter made in a reference population.

3. A method according to claim 2, characterized by the fact that the prediction involves at least two variation relationships for at least two appearance parameters, these relationships being as observed in the reference population.

4. A method according to claim 2 or claim 3, characterized by the fact that the reference population comprises a plurality of age ranges, and by the fact that for said appearance parameter at least, the relationship for variation in said parameter is determined as a function of the age ranges.

5. A method according to the preceding claim, characterized by the fact that each age range is associated with a grade representative of the appearance parameter for said age range.

6. A method according to claim 5, characterized by the fact that the representative grade is a numerical value.

7. A method according to claim 6, characterized by the fact that the representative grade is the mean value of the observed grades.

8. A method according to claim 6, characterized by the fact that the representative grade is the median value of the observed grades.

9. A method according to any preceding claim, characterized by the fact that it includes generating at least one image associated with an age range, and in particular generating a succession of images associated with different age ranges.

10. A method according to the preceding claim, characterized by the fact that each image associated with an age range for the individual constituting the subject of the prediction is generated as a function of the grade expected in said age range for at least one appearance parameter and of the appearance of said appearance parameter for at least one person in the reference population for whom the appearance parameter is evaluated as having substantially the same grade as the expected grade, or a grade that is close.

11. A method according to any preceding claim, characterized by the fact that the appearance parameter(s) are representative of aging.

12. A method according to the preceding claim, characterized by the fact that the appearance parameters are selected from: the number of crow's foot wrinkles, the severity of crow's foot wrinkles, of forehead wrinkles, of the nasolabial folds, of chin sag, of bags under the eyes, of pigment spots, of microcirculation, of baldness, of canities, and the size of pores in the face.

13. A method according to any one of claims 1 to 11, characterized by the fact that the appearance parameters are representative of gaining or losing weight.

14. A method according to any one of claims 1 to 11, characterized by the fact that the appearance parameters are representative of photo-aging.

15. A method of showing up the effects of a treatment, enabling an individual to become aware both of a first predicted result and of a second predicted result obtained by implementing a method as defined in any preceding claim, the second predicted result being obtained using one or more variation relationships that take account of the incidence of the treatment on at least one appearance parameter, the results being presented in the form of images simulating the appearance of the individual with and without treatment.

16. An atlas comprising at least three images associated with respective age ranges, the three images corresponding to different grades of at least one appearance parameter, with variation of the appearance parameter being non-linear at least for said images.

17. An atlas according to claim 16, characterized by the fact that each image associated with an age range corresponds to the grade representative of said appearance parameter in said age range for a reference population.

18. An atlas according to the preceding claim, characterized by the fact that the representative grade for an age range of the reference population is the mean grade or the median grade.

19. An atlas according to claim 18, characterized by the fact that for each age range it includes at least two images corresponding to grades that depart in predefined manner from the representative grade.

20. A system for simulating variation in the appearance of at least a portion of an individual's body, the system comprising:
means for acquiring the initial grade of at least one appearance parameter; and
means for calculating at least one expected grade for said appearance parameter as a function of a time lapse and/or a treatment, and of at least one relationship for variation in said appearance parameter as a function of time and/or of the treatment in a reference population.

21. A system according to claim 20, characterized by the fact that it includes:
graphics generator means for generating at least one image simulating the appearance of the portion of the body as a function of the grade expected for the appearance parameter.

22. A system according to claim 20 or claim 21, characterized by the fact that the calculation means are adapted to calculate the grades expected for a plurality of appearance parameters as a function of relationships for variations in said appearance parameters as observed in the reference population.

23. A method of predicting at least one appearance parameter for an external portion of the human body as a function of time and/or of a treatment, in which method the prediction is performed as a function of at least one variation relationship determined from observations of said appearance parameter made in a reference population, the result of the prediction being presented in the form of one or more images simulating the appearance of the appearance parameter(s) as a function of time and/or of the treatment.

24. An atlas comprising at least three images associated with respective age ranges, the three images corresponding to different grades of at least one given appearance parameter, each image associated with an age range corresponding to the grade that is representative of said appearance parameter in said age range for a reference population.
